(19) United States
(12) Patent Application Publication
(10) Pub. No.: US 2003/0200135 A1
(43) Pub. Date: Oct. 23, 2003

(54) System and method for predicting and preventing customer churn

(76) Inventor: Christine Ellen Wright, Aurora, IN (US)

Correspondence Address: FROST BROWN TODD, LLC, 2200 PNC CENTER, 201 E. FIFTH STREET, CINCINNATI, OH, 45202, US

(21) Appl. No.: 10/419,463

(22) Filed: Apr. 21, 2003

Related U.S. Application Data
(60) Provisional application No. 60/374,008, filed on Apr. 19, 2002.

(51) Int. Cl. G06F 17/60

(52) U.S. Cl. 705/10

(57) ABSTRACT

A system and method for predicting and preventing customer churn. One aspect of the invention is a computer system for managing customer churn. The system comprises a plurality of data sources of customer events. A churn pattern detection portion is operable to detect and predict the possibility of customer churn based on the customer event data. A churn event management portion is operable to trigger one or more customer interventions based on a predicted possibility of customer churn. A churn intervention portion is operable to receive the triggered customer interventions and executed customer contacts via one or more delivery channels.

### RELATED APPLICATIONS

This application claims the benefit of provisional application No. 60/374,008, filed Apr. 19, 2002.

### FIELD OF THE INVENTION

The present invention relates in general to computer systems for knowledge management, and will be specifically described in the context of systems and methods for predicting and preventing customer churn.

### BACKGROUND

Businesses are faced with the challenges of an emerging “customer-centric” competitive marketplace. Businesses are struggling to re-engineer their product- centric strategies and operations in order to place the customer at the core of their business. Unfortunately in many organizations, the level of resources and effort directed towards the realization of a Customer Relationship Management (“CRM”) strategy is stressing the core competency of the business. In today's environment, the competition feeds on businesses that have become distracted.

Preventing customer churn (i.e., losing existing customers) is becoming a high priority to all organizations. Consider the following:

Most companies lose 50% of their customers in 3-5 years;

It costs 7-10 times as much to acquire a new customer as it does to retain an existing customer;

A 10% spike in repeat customers adds 10% to the bottom line while a 10% decrease in customer acquisition costs adds 0.7% to the bottom line; and

Lack of improvement in customer care management costs a typical billion dollar company as much as $130 million in lost profits.

What makes these statistics even more disturbing is the fact that they prevail despite the billions of dollars and vast amounts of time and energy that has been expended on implementing “CRM Solutions” over recent years. The bottom line is that many times, a CRM implementation does not effectively predict or prevent churn and result in a costly and futile exercise on the business. Accordingly, there exists a definite need for a system and method for predicting and preventing customer churn.

### SUMMARY

One aspect of the invention is a computer system for managing customer churn. The system comprises a plurality of data sources of customer events. A churn pattern detection portion is operable to detect and predict the possibility of customer churn based on the customer event data. A churn event management portion is operable to trigger one or more customer interventions based on a predicted possibility of customer churn. A churn intervention portion is operable to receive the triggered customer interventions and executed customer contacts via one or more delivery channels.

Another aspect of the invention is a method for preventing customer churn. Customer event data from one or more sources is received and is analyzed. The possibility of customer churn is predicted based on the analyzed customer event data using rules based on statistical models. A customer intervention is triggered based on the predicted possibility of customer churn. The customer is contacted via one or more delivery channels in response to the triggered intervention. The customer contact intervention is then stored.

Yet another aspect of the invention is a customer knowledge management system. A churn management portion is operable to detect and predict customer churn based on event data and to perform customer interventions to prevent customer churn. An intelligent acquisition portion is operable to identify customer prospects based on historical customer data and to initiate a contact of the identified customer prospects. An intelligent cross-sell and upsell portion is operable to identify new or higher services for a customer and to offer the new or higher services to a customer during an interaction with the customer.

Still other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### BRIEF DESCRIPTION OF THE DRAWINGS

While the specification concludes with claims which particularly point out and distinctly claim the invention, it is believed the present invention will be better understood from the following description taken in conjunction with the accompanying drawings, in which like reference numerals identify the same elements and in which:

FIG. 1 illustrates an example of a customer knowledge management solution;

FIG. 2 illustrates an example of inputs and results of a knowledge management solution;

FIG. 3 illustrates a customer care loop relative to a knowledge management solution;

FIG. 4 illustrates examples of the effectiveness of churn management solutions;

FIG. 5 illustrates an example of a real-time churn management solution;

FIG. 6 illustrates another example of a real-time churn management solution; and

FIG. 7 illustrates an example of a predictive model for intelligent cross-selling and upselling.

### DETAILED DESCRIPTION

The present invention relates to a system and method for predicting and preventing customer churn. Businesses will enhance their understanding of customers and prospects and then transform this intelligence into individualized treatments that effectively and efficiently maximize every contact event and deepen customer relationships. Businesses are provided with intelligent customer lifecycle solutions that reinvent the customer experience. While the present invention has applicability in virtually any industry or business with customers, it is particularly useful in the telecommunication and finance industries, including without limitation for goods and services relating to cellular phones, local and long distance telephones, pagers, wireless data distribution, high and low bandwidth Internet connections, credit cards, bonds and securities, broadcast satellite media, and the like.

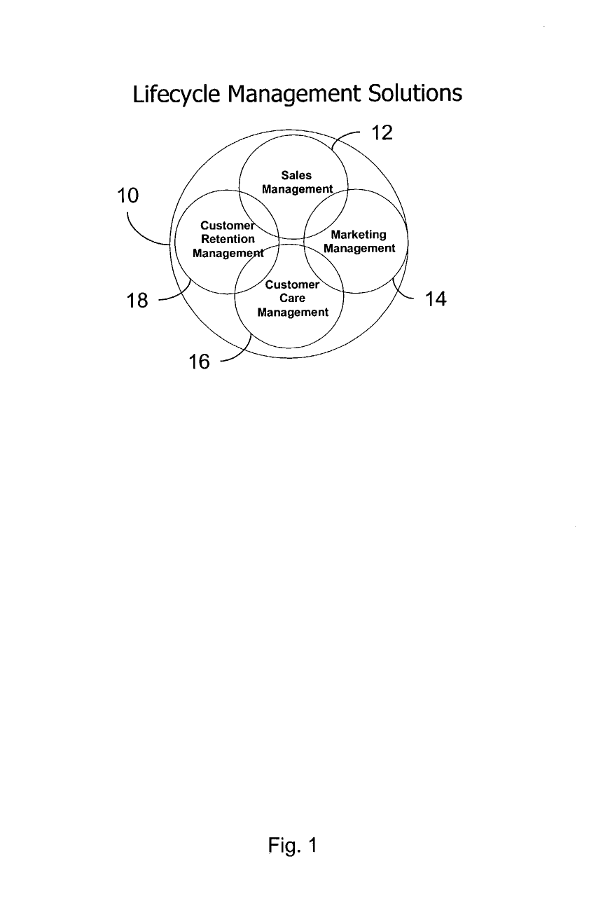

FIG. 1 schematically illustrates the functionality of a customer knowledge management solution 10. The sales management component 12 provides intelligent customer winback and intelligent customer acquisition. The marketing management component 14 provides intelligent cross-selling and upselling to existing customers. The customer care management component 16 provides intelligent customer care. The customer retention management component 18 provides intelligent customer management and customer retention to prevent churn. The solution 10 enables businesses to know when and how to respond to each customer's individual needs. The solution 10 also supports each contact with the ability to recall and reference all previous interactions with each customer. In addition, the solution 10 potentially turns every contact event into an opportunity to cross-sell, upsell and strengthen relationships. Further, the solution 10 makes every contact a point of entanglement for that customer into the business. The solution 10 also demonstrates improvements in the overall effectiveness of customer acquisition, service, retention and growth programs. The solution 10 additionally enables greater sophistication in a business' ability to strengthen its relationships with its customers.

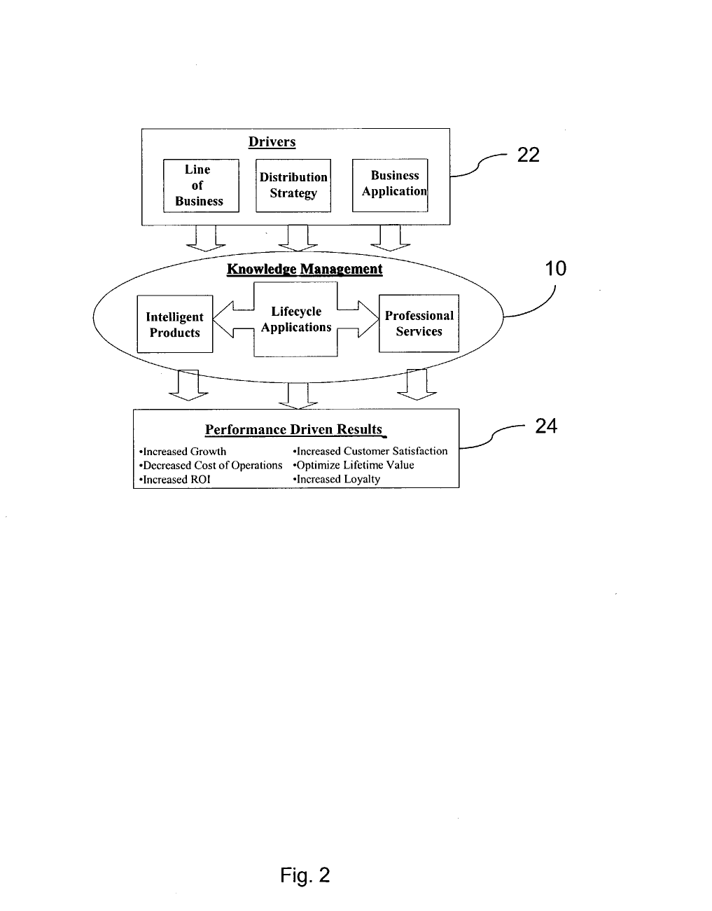

FIG. 2 illustrates an example of inputs and results of a knowledge management solution. Business drivers 22 impact an organization's ability to succeed. As shown in this example, the business drivers 22 include the line of business, the distribution strategy, and the business application. The drivers 22 are input into the knowledge management 10, which in this example couples technology with advanced marketing sciences, intelligent products and expert professional services. The knowledge management 10 results in measurable performance driven results 24 that demonstrate positive impact to the business' bottom line, including increased growth, deceased cost of operation, increased return on investment, increased customer satisfaction, optimized lifetime value, and increased customer loyalty. The knowledge management 10 maximizes the strength of data collection and management. The knowledge management 10 has the capabilities of including marketing sciences and analytical services, and the full breadth of a multi-channel contact center technology and platforms.

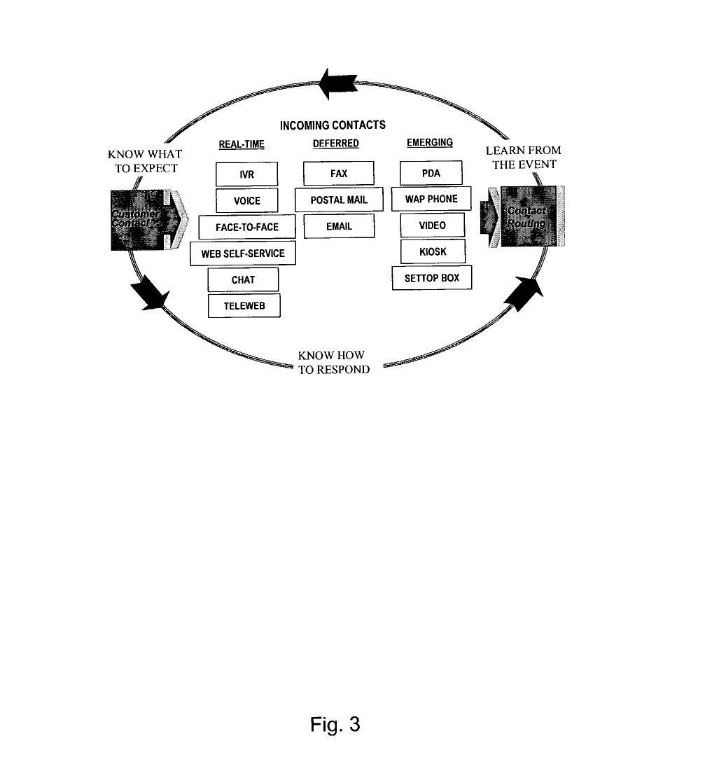

As illustrated in FIG. 3, knowledge management 10 closes the customer care loop with each and every contact and drives to a logical next best way to contact each customer. The knowledge management 10 includes marketing science experts, data, tools and processes to facilitate all of the integral elements of an effective program within each phase of the customer lifecycle. Some of the benefits that knowledge management 10 can deliver to a business include:

Improved retention rates particularly among high value and/or high potential customers;

Reduced costs by routing individuals to the most cost effective channels, based on value or propensity to buy;

Improved satisfaction by routing and queuing contacts to deliver appropriate levels of service;

Improved sales conversion rates by tailoring cross-selling and upselling offers, real-time, to present the specific product or service most suitable to a particular customer; and

Increased number of opportunities to connect with customers through iterative multi-channel contact follow- up programs.

While each business has some unique needs, by leveraged the knowledge management 10 and the multi-channel contact center environment, knowledge-enabled solutions can be customized as needed. These solutions assist businesses with meeting their objectives across the customer lifecycle, including without limitation intelligent retention, intelligent acquisition, and intelligent cross-sell and upsell.

Intelligent Retention

Several years ago, Convergys worked with two wireless carriers on a churn management pilot. The pilot included extracting historical data and building customer value and propensity to churn models for each carrier. Customers who were identified as high value and with a high propensity to churn were pro-actively contacted in outbound campaigns and provided with incentives to encourage them to stay with the carriers.

While these interventions were very effective in reducing churn for the contact groups (reduction of 50% versus control groups), the impact on overall churn was less than desired due to the structure of the pilot projects. Specifically, the cost to deploy interventions across the remaining subscriber bases on an outbound campaign basis would have been prohibitive. In addition, the churn pattern detection using only traditional analytic methods is too slow. The ability to read in transactional data from multiple disparate data sources real-time and to decision on that data is helpful for controlling churn. This is particularly true for the “less than 90 days” category which typically accounts for a very high percentage of churn.

Based on this learning, the churn management and retention solution was improved. Four components of the improved solution include churn pattern detection, churn event management, churn interventions, and closed loop analysis. Churn pattern detection includes data extraction, manipulation and mining across multiple disparate data sources, including data analysis and the development of predictive models and rules structures. For example, this might include the detection of dropped calls as they occur on a real-time basis. Churn event management includes the administration of customer and business rules for optimizing deployment of churn-related interventions. For example, a business rule might be invoked to contact a high-value customer with an e-contact intervention after the third dropped call. Churn interventions may include communications message, retention offer and contact channel management aspect of deploying churn interventions. For example, a customer could be sent a text message to their phone, e-mail address and/or the EBP site with an apology and/or a credit. Closed loop analysis includes the process of ongoing measurement, tracking, reporting and analysis of results along with recommendations for program enhancement and improvement.

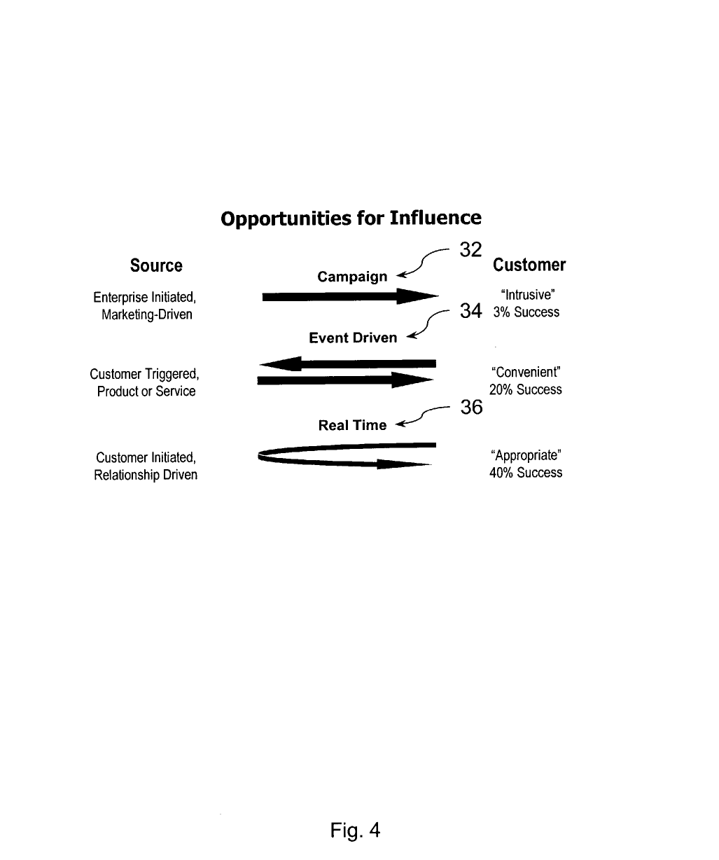

While the improved solution may be performed in a batch mode, real-time pattern detection and event management significantly enhances the effectiveness of the churn management solution over traditional batch or off-line approaches. As illustrated in FIG. 4, a typical campaign 32 using targeted efforts in an off-line manner might improve churn results by about 3% over untargeted efforts. An event driven approach 34 may achieve a 20% success. A real-time approach 36, on the other hand, might be expected to deliver results of 40%—thirteen times better than the campaign approach 32. Given the high cost of churn, this type of improvement could potentially deliver millions or even billions of dollars in cost savings and/or lifetime value for a company with millions of customers.

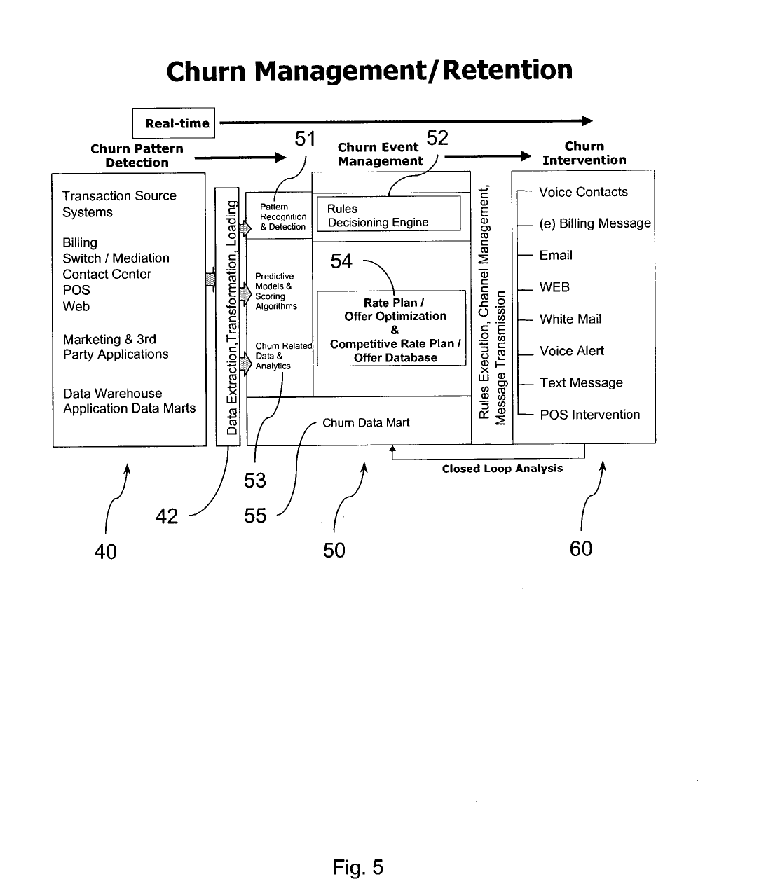

FIG. 5 illustrates an example of a real-time churn management solution, preferably implemented as executable code operating on a computer system. The solution of the present example includes three principal components: a churn pattern detention portion 40, churn event management portion 50, and a churn intervention portion 60, which together provide an end-to-end solution for detecting and preventing customer churn. In addition, the present example is a real-time solution in which data is continually processed between the various portions 40, 50, 60.

The solution starts with the churn pattern detention portion 40, which mines data from myriad sources that may be relevant to detecting customer churn. As shown in the present example, some illustrative data sources include without limitation transaction source systems; billing, switch/mediation, contact center, POS, and web; marketing and third party applications; and data warehouse applications data marts. Any one of a variety of known techniques may be employed for extracting, transforming and loading 42 the data into the churn event management portion 50.

The churn event management portion 50 itself includes several portions. The pattern recognition and detection portion 51 detect patterns of significant customer behavior in the transactional data from the churn pattern detection portion 40. The pattern recognition portion 51 builds on the customer behavior detected by the system comprises business relevant customer activity that can be inferred from the customer's current and historical interactions and known characteristics. The rules decisioning engine 52 uses the recognized and detected pattern to generate triggers for action that are transferred to the churn intervention portion 60 for processing. In other words, the sub-portions 51, 52 work together to recognize and detect customer behavior and send action triggers to customer touchpoint systems that perform appropriate actions in response to those triggers. In addition, the predictive portion 53, comprising predictive statistical models and scoring algorithms and churn related data and analytics, including without limitation exploratory data analysis, may also be used as input data for the rules decisioning engine 52 to determine the probability of a customer churning based on a given history.

Also included in the event management portion 50 is the rate plan portion 54. The rate plan portion 54 includes rate plan offer optimization algorithms and competitive rate plan offer databases. The rate plan portion 50 is a decision platform that enables consumers or agents assisting customers to quickly select the best product based on their usage patterns and needs. The platform features a flexible model that can be applied to complex product and/or service decisions. The model includes all relevant decision factors. As consumers or agents use this portion 54, it saves preferences and characteristics thus enabling service providers to retain (and up-sell) their customers, particularly those who are high value or high potential. This can be one of the data sources that feeds the rules decisioning engine 52 and enables real-time responses to customers. Alternatively, this can be scheduled to run periodically to enable periodic campaigns.

The churn intervention portion 60 enables customer contacts based on triggers to be via a live agent, however, the present example also provides a very cost-effective way to contact customers via a variety of automated delivery channels for these responses. These are personalized alerts and provide the ability for customers to take some action. These enable consumers to verify that they are the correct individuals via authentication. Delivery channels include without limitation phone (standard and wireless, voice and text), pagers (numeric, alphanumeric and two way), email, fax, eBill messaging and instant messaging. These customized alert messages can be sent to customers based on trigger information such as three dropped calls for a high value customer. The message (which can be retrieved upon authentication of identification) might offer an apology, an incentive to remain with the company such as a discount on a bill, enable a customer to interact with a customer service or retention/save group if necessary, and the like.

Consider, for example, a scenario where a customer is provided cellular phone service. The churn pattern detection portion 40 tracks a variety of information regarding the service to the customer, including the number and frequency of dropped calls, which are passed to the pattern recognition portion 51. If the customer had more that 3 dropped calls per week, the rules decisioning engine 52 acts on the threshold event and triggers an appropriate intervention to be implemented by the churn intervention portion 60. For instance, the customer could be sent a text message apologizing for the dropped call. The intervention is then stored in the churn data mart 55. If a subsequent threshold event is detected, the engine 52 may trigger a different and more aggressive intervention, such as discount or plan offer determined from the rate plan portion 54. Accordingly, a real-time and closed loop system and method monitors and prevents customer churn by proactively intervening with customers who are likely to churn.

One with ordinary skill in the art may implement any one of a variety of existing software and system implementations to configure the portions 40, 50, and and their sub-portions. Indeed, a variety of “off-the-shelf” systems may be employed in combination to achieve the novel overall system and method described above. Some suitable systems include without limitation SAS, Inc.'s ENTERPRISE MANAGER and CUSTOMER RELATIONSHIP MARKETING, Convergys, Inc.'s GENEVA, and Elity's INSIGHT, OmniChoice's OPTIMIZER, AMS's STRATA, PAR3 Communications' EVENT BASED NOTIFICATION PLATFORM or INTELLIGENT RESPONSE PLATFORM.

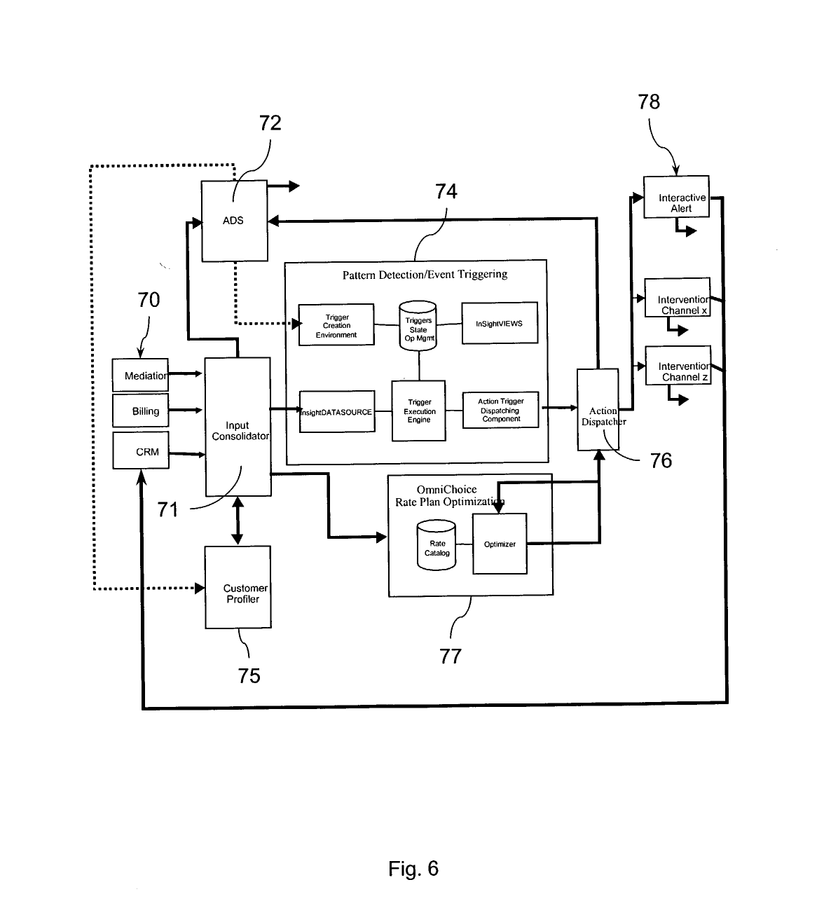

FIG. 6 is a diagram illustrating an overview of the various aspects of another example of a churn management system and method and the relationships between the various components. A variety of different data sources 70 communicate with the input consolidator portion 71. The data sources 70 can vary widely, and in this example include a mediation manager (providing customer usage information like dropped calls, completed calls, average call duration, etc.), a billing and CC system (providing customer data that can be used to establish the value of a customer, monthly events like new billing statement, adjustment data, change of address, etc.), and a call center management system (providing customer contact information).

The input consolidator 71 accepts feeds from the data sources 70 and performing filtering and/or transformation of that data prior to passing the data to other portions, such as the pattern detection engine 74 and the customer profiler 75. The input consolidator 71 is the control point of inbound data flows and is responsible for logging and auditing. It also acts as an encapsulating layer by isolating a number of data systems from third-party systems. Additionally, the input consolidator 71 maintains state with respect to a subscriber's profile. This will allow it to pre-process the ‘event’ data that it receives. In order to process the data as efficiently as possible, subscriber profile data can be held in a memory cache. The input consolidator 71 can assume all responsibilities for cache coherency. The input consolidator 71 can also act as the controller that invokes the pattern detection engine 74. Typically when a file of ‘event data’ is created and placed in the appropriate location for processing by the engine a process to execute the engine will be initiated. The input consolidator 71 includes an API that directly supplies profile data to other portions, such as the pattern detection engine 74, for customers whom inactivity events are coming due.

The data is passed to the analytic and reporting platform (also known as ADS) 72, which comprises a set of analytic and reporting tools (e.g. SAS and business objects). Statisticians will use this platform 72 to develop models that can predict a customer's propensity to churn. This modeling will identify what data elements need to be provided as input to the pattern detection engine 74 as well as what rules should exist. This platform 72 may also be used to develop a set of performance reports that demonstrate both the effectiveness of the churn prevention interactions and the success of predicting that a given customer would indeed churn.

When modeling churn, the analysis portion of the platform 72 can use sample data from a variety of sources 70 in order to validate the statistical hypotheses being tested. This data would be refreshed on a ‘per request’ basis and would typically be delivered via a set of flat files from the input consolidator 71. The platform 72 can output a set of validated tests that will identify the parameters of interest when defining business rules in the pattern-matching engine. The platform 72 will produce a set of validated tests that will define ultimately define the scoring mechanism in the customer profiler 75. During closed-loop analysis, the platform 72 gathers performance data by executing public APIs on the action dispatcher component 76. The analysis of the data will result in a set of reports showing the effectiveness of interventions.

The customer profiler 75 assigns a ‘score’ to a customer based on a set of analytics. The score is used as part of the rules to determine the type of intervention and whether or not an intervention is warranted. This score is provided as an input parameter to the pattern detection engine 74 to be evaluated as part of the established business rules. The score for a customer can be re-evaluated based on events that have occurred through the external data sources 70, such as billing, -customer care, usage, market changes, and other external factors. Since the characteristics that drive the score are dynamic in nature, the profiler 75 may be parameter driven to eliminate the need for long lead times and development cycles. In the present example, the profiler 75 does not maintain state about any given customer, but is a mechanism to provide scoring of a subscriber's value to the enterprise, propensity to churn, propensity to respond to certain offers, etc.

The customer profiler 75 includes a real-time API that provides the ability to score a particular subscriber. A collection of data about that customer is provided as input (including their current score value) and based on a set of business rules the score values are reset and the updated profile returned. A boolean value for success/failure will also be returned. A GUI can be provided to allow the established scoring parameters to be fine tuned without the need for additional programming. The ADS 72 can provide a set of parameters that drive scoring rules that will be modifiable via a GUI.

The pattern detection engine 74 supports the ability to recognize patterns and significant events in the available data relevant to predict customer churn, as well as the ability to manage and trigger customer intervention events. The patterns are based on a set of rules that are driven by the statistical analysis from the ADS 72. The trigger execution engine component creates consumable actions based on the recognition of patterns and events identified by the pattern detection engine 74. Once a trigger is activated it raises an event that identifies the type of customer interaction. These events are passed to the action dispatcher 76. While various software solutions may be employed, the present example implements the Elity INSIGHT product to provide an integrated pattern detection and event-triggering component. The creation of rules can be accomplished via a GUI provided with the INSIGHT product. A GUI can be used to allow for the creation of business rules as they pertain to the detection and notification of patterns and events. The pattern detection engine 74 receives data feeds from the input consolidator 71. This can be achieved by placing relevant transaction files in the pre-determined directories in the INSIGHT environment. The events raised by the pattern detection engine 74 are presented in real-time to the action dispatcher 76.

The action dispatcher 76 is a controller that is responsible for consuming the events raised by the triggering component of engine 74 and forwarding these messages in an appropriate format to the targeted receivers. It also acts as a repository for both completed and yet to be completed intervention requests. Data for completed intervention requests can be subject to some migration requirements in order to keep the data store of a manageable size. The action dispatcher 76 includes several programmatic interfaces, including an interface to receive an actionable events, an interface to log the results of a particular intervention channels handling of a given action request, an interface to retrieve completed interaction requests based on the event ID value, and an interface to retrieve completed interaction requests based on the ID of the channel that processed the request. A GUI allows for event types to be targeted to a primary and secondary intervention channels.

The rate plan optimizer (RPO) 77 analyzes customer usage and other profile data to suggest more appropriate rate plans for a customer. It can link usage patterns with plan details to identify the plan that is most applicable to a customer's situation. The RPO 77 can be updated regularly with rate plan data from both the business and its competitors. The triggering action can supply all of the information necessary to do the rate plan analysis. An XML interface allows the RPO 77 to receive updates to its own rate plan catalog. A public interface can initiate rate plan optimization requests, preferably through a synchronous transaction. The interface will return an ordered list of available plans with a ranking of suitability for the subscriber. Data is passed to the RPO 77 from the action dispatcher 76 in the event that the interaction is targeted for rate plan optimization. Data is returned from the RPO 77 containing the plan recommendation.

The interactive alert engine 78 is responsible for consuming events passed from the action dispatcher 76 through a variety of different delivery channels. Results from the intervention are posted back to the CRM, which results can then be used for later processing in the churn management system.

In addition to churn management, the system and method discussed above can be integrated with additional known knowledge management portions, such as intelligent acquisition and intelligent cross-sell and upsell systems and method, thus providing a total customer lifecycle solution.

Intelligent Acquisition

Many businesses are challenged to acquire more customers each year, but often with more limited budgets to do so. Their objectives therefore include reducing costs per sale, maximizing sales conversion rates/sales per hour, minimizing product return rates and/or churn and optimizing revenue per sale. Rather than contacting a large list of customer prospects who may or may not be interested in a business's goods or services, it can be better to use historical customer data to determine which prospects (including former customers for winback) should be contacted in order to ensure the greatest possibility for success.

An example of a solution that includes knowledge management would start with the development of an analytic plan and then the reception of a historical data extract file from a business. The file is then merged/purged and third party data is appended as required by the analytic plan. A model is built to identify those prospects that are most likely to respond positively to the offer. This includes setting up appropriate tests and campaigns and measuring the results in a closed loop process. Changes are made to the program and/or to the model as required to ensure that results are continuously improved.

For example, a national wireless carrier had found that their acquisition efforts in the consumer market were becoming less and less successful. Knowledge management was engaged by the business to develop a response model. The table below compares the results without the model and with the model.

| Metric | Without Model | With Model | Difference |
|---|---|---|---|
| Sales per Hour | .35 | .44 | 26% |
| Cost per Sale | $85 | $68 | −20% |

Given the excellent results to date, a further enhancement is currently being implemented. The number of passes for the top groups will be increased so that more focus can be placed on these high potential buyers. These results indicate that this will result in at least an additional 6% increase in sales per hour and a reduction in cost per sale of 6%.

Another example includes a business-to-business credit card company's efforts to acquire new merchants who would accept the company's credit card in their establishments. Their acquisition efforts were not producing the required returns. Data about the client's current business-to-business customers was consolidated along with data from past marketing campaigns and third party firmographic data. A “propensity to accept” model was developed and utilized to rank-order the prospect list and to make outbound contacts. The test campaign resulted in a 70% increase in the conversion rate over the average conversion rate, i.e. 9.5% versus 5.6%. The estimated cost per sale was reduced by approximately 41%.

Intelligent Cross Sell and Upsell

Just as companies are faced with acquiring more customers with fewer budget dollars, these organizations must also work to grow and optimize their relationships with their customers in the most cost-effective manner possible. In many cases, it is possible to utilize successful customer service or technical support interactions to cross-sell or upsell to customers and deepen these customer relationships. In addition, an initial acquisition campaign or another marketing campaign can be leveraged for effective cross-sell or upsell efforts provided that data is available and is used intelligently during the contact event.

Correctly matching customers with the most relevant cross-sell or up-sell offers allows clients to maximize their results and minimize the costs associated with customer interactions. This more targeted approach to selling increases return on investment by:

Delivering cross-sell offers via the most effective and least cost channel(s) for each customer or customer group.

Allocating contact handle time wisely, whether inbound or outbound, to focus on product(s) that the customer has a propensity to want or need.

Increasing sales per hour and overall revenues.

Maximizing customer lifetime value.

Intelligent cross sell and upsell solutions maximize conversion rates and minimize the costs associated with each sale. The solutions leverage the strength of data collection and analysis capabilities to determine what to offer to each customer, when to offer it, and even the right channel for the interaction. For instance, the solutions can target:

The specific customers to be offered a cross-sell/upsell during a successful customer service or technical support interaction.

The customers to receive a follow-up sales contact following successful resolution of their customer service issue or technical support case.

The prioritization of outbound follow-up efforts against a customer list.

The number of outbound attempts made to reach each customer.

The channels to be included in outbound cross-sell contacts.

The specific product, service, or bundle to be included in the cross-sell effort.

The agent that handles specific customer interactions in an inbound sales environment. For example, contacts to the sales center can be routed to varying agent groups based upon customer (or prospect) profile and agent skill sets.

In one example, a business was a local access carrier. The business was interested in cross-selling and upselling a variety of existing and new custom calling features (singly or in bundles) to selected customers. Based on the business' objectives, knowledge management developed an analytic plan and then obtained a data extract of current customers along with product ownership data and appended third party data to the file. The solution included the following components (also shown in the diagram below):

Segmented customers into groups using a segmentation study

Developed a multi-product predictive model to further differentiate customers

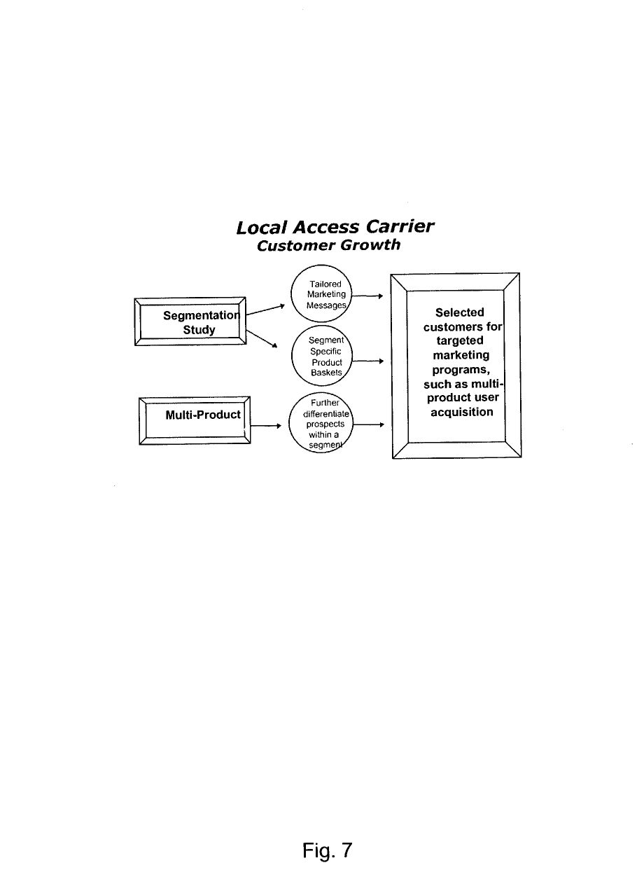

Created new product bundles targeted to groups of customers using the predictive model illustrated in FIG. 7.

After the analytics were developed, they were tested in a direct mail campaign that was targeted to 120,000 customers out of a two million plus customer base. Marketing messages were tailored for each customer segment. A control group was created from the customer base before the selection criteria were applied so that it would be possible to validate the segmentation and model analyses. An inbound telemarketing campaign was set up to support the campaign. This very successful campaign resulted in a 3.5% response rate for the targeted group versus a 2.4% response rate for the control group or a 45% increase. The cost per sale for the targeted group was also approximately 35% lower than that for the control group.

As demonstrated by the solutions and cases described above, using customer knowledge in an integrated contact center helps businesses improve the effectiveness of their sales, marketing and customer care programs. The solutions integrate sophisticated data warehousing, analytical techniques, advanced technology, and best-in-breed contact center operations into a seamless system for acquiring, serving, retaining and growing customers.

Having shown and described various embodiments of the present invention, further adaptations of the methods and systems described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of structure and operation shown and described in the specification and drawings.

What is claimed is:

1. A computer system for managing customer churn, the system comprising:
a) a plurality of data sources of customer events;
b) a churn pattern detection portion operable to detect and predict the possibility of customer churn based on the customer event data;
c) a churn event management portion operable to trigger one or more customer interventions based on a predicted possibility of customer churn; and
d) a churn intervention portion operable to receive the triggered customer interventions and executed customer contacts via one or more delivery channels.

2. The system of claim 1, wherein the pattern detection portion is based on one or more rules as a function of the detected events.

3. The system of claim 2, wherein the rules are based on statistical models relevant to churn.

4. The system of claim 2, wherein the rules determine a customized intervention.

5. The system of claim 2, wherein the rules are a function of a customer score.

6. The system of claim 1, wherein the data sources, churn pattern detection portion, churn event management portion, and churn intervention portion operate as a closed loop system.

7. The system of claim 1, wherein the system operates in real-time.

8. The system of claim 1, further comprising a customer profiler portion.

9. The system of claim 8, wherein the customer profiler portion assigns a customer score to a customer which is used by the pattern detection portion.

10. The system of claim 1, further comprising a rate plan optimization portion.

11. The system of claim 1, further comprising intelligent customer acquisition functionality.

12. The system of claim 1, further comprising intelligent cross-sell and upsell functionality.

13. A method for preventing customer churn, comprising the steps of:
a) receiving customer event data from one or more sources;
b) analyzing the customer event data;
c) predicting the possibility of customer churn based on the analyzed customer event data using rules based on statistical models;
d) triggering a customer intervention based on the predicted possibility of customer churn;
e) contacting the customer via one or more delivery channels in response to the triggered intervention; and
f) storing the customer contact intervention.

14. The method of claim 13, wherein the steps are performed in real time.

15. The method of claim 13, further comprising the step of using the stored customer contact intervention for subsequent steps of analyzing, predicting and triggering.

16. The method of claim 13, wherein the intervention is customized.

17. The method of claim 13, further comprising the step of intelligent cross-selling an upselling to customers.

18. The method of claim 13, further comprising the step of intelligent acquiring of customers.

19. The method of claim 13, wherein the one or more of the steps are performed simultaneously.

20. The method of claim 13, wherein the steps are performed sequentially.

21. A computer system comprising instructions operable to perform the method of claim 13.

22. A computer readable medium comprising instructions operable to perform the method of claim 13.

23. A customer knowledge management system, comprising:
a) a churn management portion operable to detect and predict customer churn based on event data and to perform customer interventions to prevent customer churn;
b) an intelligent acquisition portion operable to identify customer prospects based on historical customer data and to initiate a contact of the identified customer prospects; and
c) an intelligent cross-sell and upsell portion operable to identify new or higher services for a customer and to offer the new or higher services to a customer during an interaction with the customer.
